(19) United States
(12) Patent Application Publication
(10) Pub. No.: US 2011/0164848 A1
(43) Pub. Date: Jul. 7, 2011

(54) Ball Lens Holder For A Planar Lightwave Circuit Device

(75) Inventor: Cristian Bolle, Bridgewater, NJ (US)

(73) Assignee: Alcatel-Lucent USA Inc., Murray Hill, NJ (US)

(21) Appl. No.: 12/683,516

(22) Filed: Jan. 7, 2010

(51) Int. Cl. G02B 6/32; B29D 11/00

(52) U.S. Cl. 385/35; 216/24

(57) ABSTRACT

In a planar lightwave circuit (PLC) package, a ball lens is used to broaden a collimated beam from a waveguide in a PLC device. A holder for the ball lens is attached to the PLC device in the package, which attachment effects a passive alignment of the waveguide with the ball lens to achieve efficient optical coupling therebetween.

### FIELD OF THE INVENTION

The invention relates to a technique for realizing a planar lightwave circuit (PLC) package and, more particularly, to a technique for designing a ball lens holder for use in the package.

### BACKGROUND OF THE INVENTION

This section introduces aspects that may help facilitate a better understanding of the invention. Accordingly, the statements of this section are to be read in this light and are not to be understood as admissions about what is prior art or what is not prior art.

When packaging a planar lightwave circuit (PLC) device it is common to interface its input or output port with the outside of the package via a collimated beam. A collimating ball lens oftentimes is used in the package to couple the light in or out of a waveguide in the PLC device. The hall lens typically is held by metallic clips laser-welded onto the PLC device. Only after an active alignment of the optical axis of the ball lens with that of the waveguide is performed, which involves shining laser light through the waveguide and finely adjusting the ball lens' position, are these clips welded in place.

### BRIEF SUMMARY

The invention is premised upon the recognition of labor intensiveness of the active alignment of a ball lens with a waveguide in packaging a PLC device, which is not conducive to a mass production of the package. The invention overcomes such limitations by passively aligning the ball lens with the waveguide. In accordance with one embodiment of the invention, a lens holder comprises one or more alignment elements for connecting the holder to a planar lightwave circuit (PLC) device. The alignment elements are configured to align a lens (e.g., a ball lens) disposable on the holder with a waveguide in the PLC device to effect optical coupling between the lens and the waveguide. The lens holder also includes a cavity for placement of the lens therein, with one or more sidewalls of the cavity being configured to support the lens.

### BRIEF DESCRIPTION OF THE DRAWINGS

FIG. 1 provides a perspective view of an arrangement including a PLC device and ball lens holder in one embodiment of the invention;

FIGS. 2A, 2B and 2C depict a manufacture process of a light waveguide portion in the arrangement of FIG. 1;

FIG. 3 provides a top view of the arrangement of FIG. 1;

FIGS. 4A, 4B and 4C depict a manufacture process of the ball lens holder in the arrangement of FIG. 1;

FIG. 5 provides a cross-sectional view of a package containing the arrangement of FIG. 1; and

FIG. 6 provides a top view of a ball lens holder in accordance with another embodiment of the invention.

### DETAILED DESCRIPTION

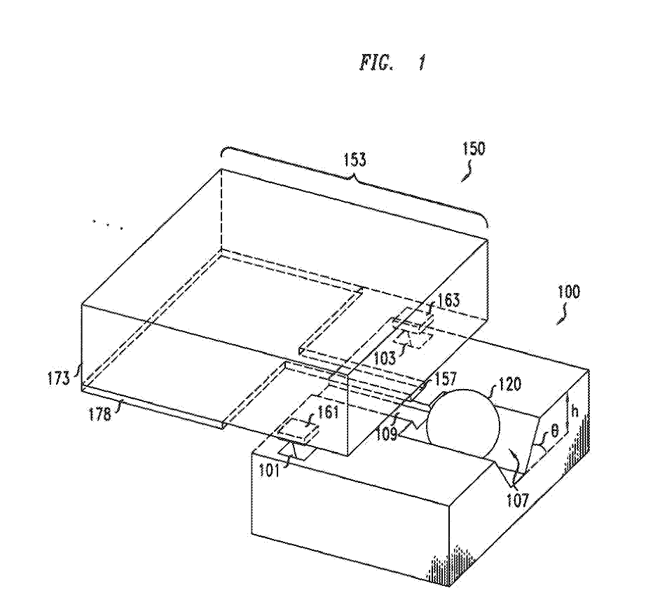

FIG. 1 provides a perspective view of an arrangement embodying the principles of the invention, where PLC device 150 is mountable onto ball lens holder IOU. Device 150 includes light waveguide portion 153 and other parts of the device, which are not shown and which are not germane to this embodiment of the invention. Portion 153 is fabricated from a waveguide wafer which includes a glass layer laminated on a silicon substrate. As described in further detail below, in one embodiment, reactive ion etching (RIE) is used to remove parts of the glass layer of the wafer, leaving behind waveguide 157 and rectangular islands 161 and 163. As a result, waveguide 157, and islands 161 and 163 each protrude from silicon substrate 173, with their height equal to that of glass layer 178.

In one embodiment, ball lens holder 100 is fabricated from a silicon wafer. As described in further detail below, anisotropic silicon etching (e.g., KOH etching) is used to remove parts of the silicon wafer to form ball lens cavity 107 and alignment cavities 101 and 103. In this instance, ball lens cavity 107 is cylindrical and has a trapezoidal cross-section. In addition, RIE is used to remove part of the silicon wafer to form trench 109. In another embodiment, mechanical cutting using, e.g., a dicing saw is performed to remove the part of the silicon wafer to form trench 109.

During packaging of PLC device 150, light waveguide portion 153 is pressed onto ball lens holder 100 such that trench 109 receives and accommodates protruding waveguide 157. In addition, protruding islands 161 and 163 fit into alignment cavities 101 and 103, respectively, allowing minimal lateral movements of the islands in the package. As a result, PLC device 150 is attached to ball lens holder 100 in the package and, at the same time, a passive alignment of waveguide 157 with ball lens holder 100 is thereby achieved such that the optical axis of waveguide 157 is aligned with that of ball lens 120 disposed on cavity 107, with efficient (if not optimal) optical coupling between waveguide 157 and lens 120. It should be noted that because ball lens 120 is used here to broaden a collimated beam from waveguide 157, the alignment need not be exact to achieve the efficient optical coupling.

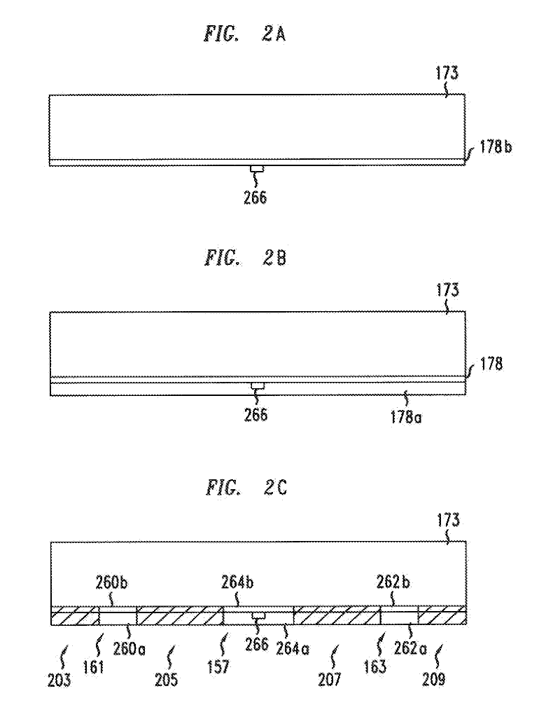

FIG. 2C shows a cross-section of light waveguide portion 153 when cutting across island 161, waveguide 157 and island 163, with shaded parts (denoted 203, 205, 207 and 209) of the glass layer of the waveguide wafer (from which portion 153 is fabricated) removed using the aforementioned RIE. As shown in FIG. 2C, island 161 comprises a glass layer laminated on silicon substrate 173. This glass layer consists of upper clad layer 260a and lower clad layer 260b. Similarly, island 163 comprises a glass layer laminated on silicon substrate 173. This glass layer consists of upper clad layer 262a and lower clad layer 262b. Waveguide 157 consists of upper clad layer 264a with core layer 266 embedded therein, and lower clad layer 264b laminated on silicon substrate 173.

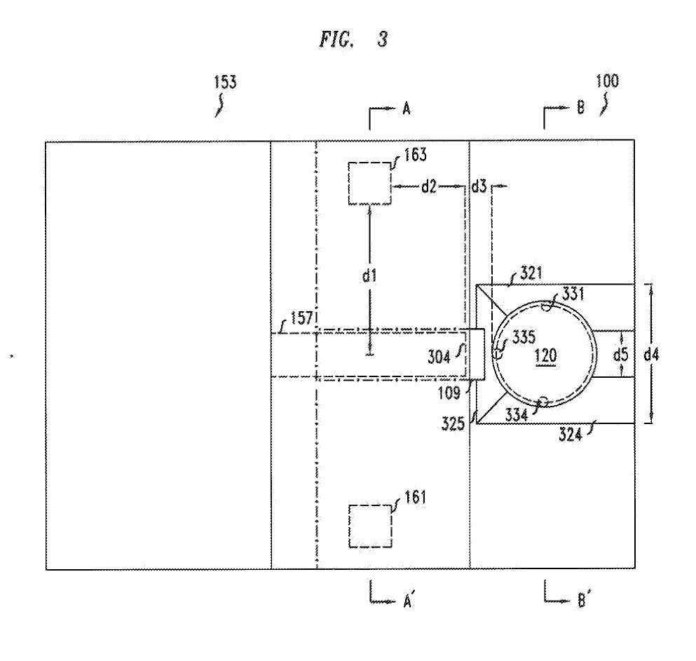

FIG. 3 provides a top view of the arrangement of FIG. 1. As shown in FIG. 3, islands 161 and 163 are disposed on light waveguide portion 153 symmetrically about waveguide 157. Specifically, in this embodiment, the respective distances from the islands to the center of waveguide 157 both are d1. In addition, the respective distances from the islands to end face 304 of waveguide 157 both are d2. Similarly, alignment cavities 101 and 103 (whose views are obstructed by islands 161 and 163 in FIG. 3) are disposed on ball lens holder 100 symmetrically about trench 109. The respective distances from the alignment cavities to the center of trench 109 both are d1. In addition, the respective distances from the alignment cavities to ball lens 120 both are d2+d3, where d3 in this instance is the focal length of lens 120. The widths of the top and bottom of trapezoidal cavity 107 are d4 and d5, respectively, where d4 is greater than d5 to provide a large pupil for a collimating beam exiting ball lens 120. It should be noted that ball lens 120 in this embodiment makes contact with side walls 321, 324 and 325 of cavity 107 at three points (denoted 331, 334 and 335), respectively. In one embodiment, thermo compression bonding is used to secure the position of ball lens 120 on cavity 107. In a well known manner, the thermo compression bonding is formed by coating at least the area of cavity 107 where hall lens 120 is to contact cavity 107 with an aluminum layer. Ball lens 120 is then pressed against the aluminum coating when heated to form aluminum oxide bonding at points-of-contact 331, 334 and 335. For details on achieving one such aluminum oxide bonding, one may refer to U.S. Pat. No. 5,178,319 issued to Coucoulas, which is incorporated herein by reference.

Referring also to FIG. 1, given a diameter of ball lens 120, the height (h) of cavity 107 and the respective slopes of side walls 321, 324 and 325 determine an elevation of ball lens 120 in holder 100, and thus the degree of alignment of the optical axis of waveguide 157 with that of ball lens 120, i.e., the efficiency of optical coupling therebetween. In one embodiment, side walls 321, 324 and 325 have the same elevation angle θ=54.73° and thus the same slope. The angle θ is subject to the crystal structure and orientation of the silicon material used to fabricate holder 100, and anisotropic silicon etching applied to the material. In an embodiment where ball lens 120 has a 0.5 mm diameter, d3=123 μm, d4=642 μm, and h=300 μm. It should be noted that the distance measurements including d1, d2, d3 and d4 in the embodiment are lithographically determined and thus are precise, thereby effectively achieving the passive alignment in accordance with the invention.

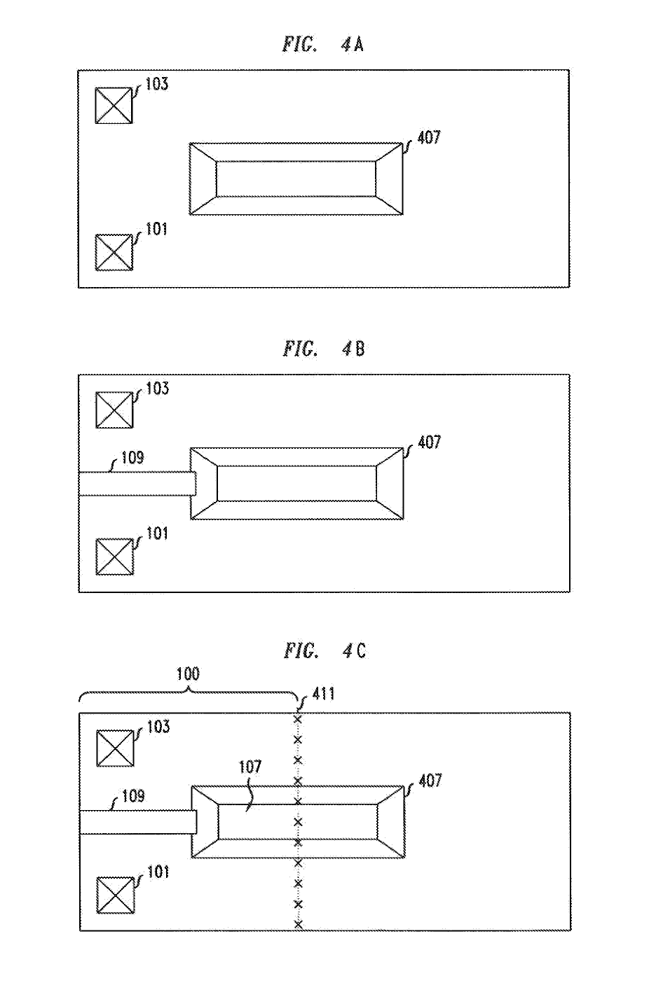

FIGS. 4A, 4B and 4C depict steps A, B and C in a process for manufacture of ball lens holder 100. In one embodiment, ball lens holder 100 is fabricated from a silicon wafer. In step A, KOH etching is used to remove parts of the silicon wafer to form trapezoidal ditch 407 and alignment cavities 101 and 103, the result of which is shown in FIG. 4A. In step B, RIE or, alternatively, mechanical cutting (e.g., using a dicing saw) is performed to remove part of the silicon wafer to form trench 109, the result of which is shown in FIG. 4B. In step C, part of the silicon wafer is mechanically cut off (e.g., using a dicing saw) to form cavity 107, which cut is made across trapezoidal ditch 407 along crossed line 411 shown in FIG. 4C, resulting in ball lens holder 100.

FIGS. 2A, 2B and 2C collectively depict a process for manufacture of light waveguide portion 153 in one embodiment. Portion 153 is formed by first laminating lower cladding layer 178b on silicon wafer 173. Layer 178b is patterned and etched to accommodate core layer 266, which is a film of glass having a different refractive index than layer 178b. A cross-section of the resulting structure is shown in FIG. 2A, on which upper cladding layer 178a is laminated, with core layer 266 embedded in layer 178a. A cross-section of the resulting waveguide wafer is shown in FIG. 2B. RIE is then performed on the waveguide wafer to remove parts of cladding layers 178a and 178b (i.e., shaded parts 203, 205, 207 and 209), resulting in light waveguide portion 153 in FIG. 2C as described before.

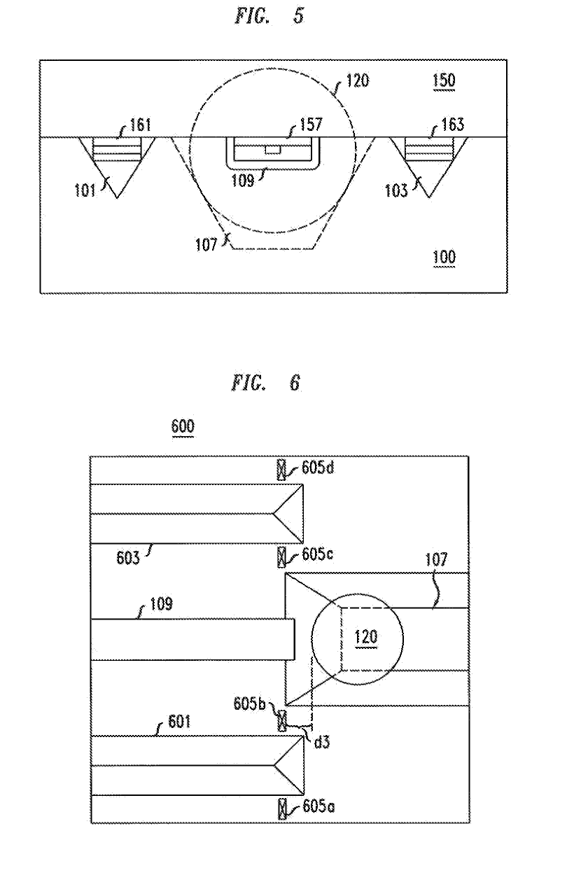

During packaging of PLC device 150, light waveguide portion 153 is mounted onto ball lens holder 100 in the manner described before, and is attached thereto, e.g., by soldering or using epoxy. The resulting package is shown in FIG. 5, which provides a cross-sectional view of the package (in solid line) after cutting it along line A-A′ in FIG. 3, superimposed with a second cross-sectional view of the package (in dashed line) after cutting it along line B-B′ in FIG. 3.

Another embodiment of the invention will now be described, which is premised upon the recognition that the aforementioned RIE for removing cladding parts 203, 205, 207 and 209 from the waveguide wafer may result in striation of end face 304 of waveguide 157, which may adversely affect the optical coupling between waveguide 157 and ball lens 120. According to this embodiment, light waveguide portion 153, as manufactured in the manner described above, is further processed by cutting and polishing the end of portion 153 facing ball lens 120 to render the surface of end face 304 smooth. As a result, in this embodiment, the actual distance (d2) between end face 304 and an alignment island (161, 163) can no longer be precise, thus adversely affecting the passive alignment of waveguide 157 with ball lens 120. To rectify any such misalignment, ball lens holder 100 has been modified in this embodiment. The modified ball lens holder is shown and denoted 600 in FIG. 6. Holder 600 differs from holder 100 in that, among other things, alignment cavities 101 and 103 in holder 100 are replaced with alignment grooves 601 and 603, respectively. In addition, one or more notches, e.g., notches 605a, 605b, 605c and 605d are etched on holder 600, with their lateral distance to ball lens 120 being precisely d3, i.e., the focal length of ball lens 120. With holder 600, the passive alignment of waveguide 157 with ball lens 120 is achieved by sliding alignment islands 161 and 163 of portion 153 onto grooves 601 and 603 of holder 600 towards ball lens 120 until the end of portion 153 facing lens 120 matches up and aligns with notches 605a, 605b, 605c and 605d.

The foregoing merely illustrates the principles of the invention. It will thus be appreciated that those skilled in the art will be able to devise numerous arrangements which embody the principles of the invention and are thus within its spirit and scope.

For example, in the disclosed embodiments, two protruding islands (i.e., 161 and 163) and corresponding alignment cavities (or grooves) are used for connection of PLC device 150 to ball lens holder 100. It will be appreciated that a person skilled in the art may, instead, use one, three or more islands and corresponding cavities (or grooves) for such a connection to suit his/her particular needs.

In addition, in the disclosed embodiments, the set of protruding islands and the set of corresponding alignment cavities (or grooves) respectively are arranged symmetrically about an optical axis. It should be pointed out that this need not be the case as long as the two sets follow the same pattern.

Further, it will be appreciated that a person skilled in the art would use the protruding islands and alignment cavities (or grooves) interchangeably such that PLC device 150 may have thereon one or more protruding islands and/or alignment cavities (or grooves), and ball lens holder 100 may have thereon the corresponding one or more alignment cavities (or grooves) and/or protruding islands for the passive alignment.

Moreover, notches (e.g., 605a-d) are used in one of the disclosed embodiments for the passive alignment. It will be appreciated that a person skilled in the art would apply one or more notches or other indicia on one or both of PLC device 150 and ball lens holder 600 to similarly accomplish the passive alignment.

Finally, it is understood that the invention includes combinations of a part of or the whole part of the structures described in each illustrative embodiment.

What is claimed is:

1. A lens holder apparatus, comprising:
a body including a cavity for placement of a lens therein, wherein one or more sidewalls of the cavity are configured to support the lens; and
one or more alignment elements for connecting the apparatus to a planar lightwave circuit (PLC) device, wherein the alignment elements are configured to align the lens with a waveguide in the PLC device to effect optical coupling between the lens and the waveguide.

2. The apparatus of claim 1 wherein the alignment elements include cavities.

3. The apparatus of claim 1 wherein the alignment elements include grooves.

4. The apparatus of claim 1 wherein the body further includes one or more indicia thereon for aligning the lens with the waveguide.

5. The apparatus of claim 1 wherein the body further includes a trench for accommodating a waveguide in the PLC device.

6. The apparatus of claim 1 wherein the cavity has a trapezoidal cross-section.

7. The apparatus of claim 1 wherein the lens includes a ball lens.

8. The apparatus of claim 7 wherein the cavity has three or more sidewalls, and the ball lens when placed in the cavity makes contact with three of the sidewalls.

9. A package, comprising:
a PLC device having one or more first alignment elements; and
a lens holder having one or more second alignment elements for connection with the one or more first alignment elements, respectively, to align a lens disposable on the lens holder with a waveguide in the PLC device to effect optical coupling between the lens and the waveguide.

10. The package of claim 9 wherein at least one of the first alignment elements is protrusive.

11. The package of claim 10 wherein at least one of the second alignment elements is receptive to the at least one first alignment element.

12. The package of claim 9 wherein at least one of the first alignment elements comprises one or more cladding layers.

13. The package of claim 9 wherein the lens includes a ball lens.

14. The package of claim 9 wherein the lens holder has one or more indicia thereon for aligning the lens with the waveguide.

15. A method for fabricating a lens holder from a wafer, comprising:
etching the wafer to form therein a ditch, one or more alignment elements for connection to a PLC device to align a waveguide in the PLC device with a lens disposable on the lens holder, and a trench for accommodating the waveguide; and
cutting off part of the wafer having the ditch therein, which cut is made across the ditch to form a cavity for placement of the lens therein.

16. The method of claim 15 wherein the wafer comprises a silicon wafer.

17. The method of claim 16 wherein the ditch and alignment element are formed by etching the silicon wafer using an anisotropic silicon etching technique.

18. The method of claim 17 wherein the anisotropic silicon etching technique includes a KOH technique.

19. The method of claim 16 wherein the trench is formed by etching the silicon wafer using au RIE technique.

20. The method of claim 17 wherein the part of the wafer is cut off using a saw.

21. The method of claim 17 further comprising etching on the wafer one or more indicia for aligning the waveguide with the lens.
